(19) United States
(12) Patent Application Publication
(10) Pub. No.: US 2017/0030840 A1
(43) Pub. Date: Feb. 2, 2017

(54) METHOD AND DEVICE FOR REMOTE ENDOSCOPY OF AN AIRCRAFT ENGINE

(71) Applicant: SNECMA, Paris (FR)

(72) Inventors: Florie BUGEAUD-REMOND, Issy Les Moulineaux (FR); Lydie Marie-Helene CHEVALIER, Moissy-Cramayel (FR); Christophe FOLLIOT, Courcouronnes (FR); Bemard LHERMENIER, Ris Orangis (FR); Jacques MARTIN, Bry Sur Marne (FR)

(73) Assignee: SNECMA, Paris (FR)

(21) Appl. No.: 15/303,169

(22) PCT Filed: Apr. 10, 2015
(86) PCT No.: PCT/FR2015/050970

§ 371 Date: Oct. 10, 2016

(30) Foreign Application Priority Data
Apr. 11, 2014 (FR) 14 53254

(51) Int. Cl. G01N 21/88; G07C 5/00; G07C 5/08; B64F 5/00

(52) U.S. Cl. CPC G01N 21/8851; B64F 5/0045; G07C 5/008; G07C 5/0808; G01N 2021/8887; G01M 15/02

(57) ABSTRACT

The invention relates to a device for aiding remote-diagnosis in the course of an endoscopy of an aircraft engine, comprising at least one endoscope used in situ by a first operator to capture images of said engine and to perform measurements, and at least one remote terminal used by at least one second operator to analyse said video images and to transmit a diagnosis to the operator.

The device according to the invention further comprises a wireless communication interface allowing the operator to exchange with the expert, in real time and interactively, the images captured and the results of the measurements performed.

### FIELD OF THE INVENTION

The invention is situated in the field of aircraft engine inspection during development or during maintenance after landing following a flight, or in scheduled maintenance, and relates more specifically to a device for aiding remote-diagnosis in the course of an endoscopy of an aircraft engine; said device comprising at least one endoscope used in situ by a first operator to capture images of said engine and to perform measurements, and at least one remote terminal used by at least one second operator to analyse said images and the results of said measurements with a view to establishing a diagnosis.

The invention further relates to a computer program stored in memory on a storage medium and including instructions for carrying out the steps of the method.

### STATE OF THE RELATED ART

During the maintenance of an aircraft engine after landing following a flight, in scheduled maintenance or during aircraft engine propulsion assembly or component development tests, the items are checked and tested in situ by operators either at the foot of the aircraft wing or in development, test or maintenance facilities, and sometimes dismantled for evaluation by other operators who may be experts in specific technical fields of aircraft engines. The latter are not always located on the inspection and testing site and generally need to travel to view the condition of the components and provide the operators with technical opinions and advice.

The decisions need to be taken quickly and unambiguously in order to assess the levels of damage and enable a prompt return to aircraft operation, or in order to complete the test campaign.

One aim of the invention is that of performing a diagnosis based on reliable information in order to shorten the endorsement interval for an aircraft engine if the latter is to fly again.

A further aim of the invention is that of providing the experts with accurate information, notably, measurements and images made in key zones in order to establish a diagnosis.

### DESCRIPTION OF THE INVENTION

This aim is achieved by means of a device and method enabling operators located on the inspection and testing site to communicate in real time with remote operators, to exchange information in the course of an endoscopy of an aircraft engine, making it possible to rapidly identify and view any faults, and make the necessary decisions (for example in terms of corrective actions).

This device comprises at least one endoscope or one camera used in situ by a first operator to capture video images of said engine and to perform measurements, and at least one remote terminal used by at least one second operator, who may be an expert for example, to analyse said images and the results of said measurements with a view to establishing a diagnosis, and to transmit a diagnosis to the operator.

According to the invention, the device further comprises a communication interface allowing the first operator to exchange with the second operator, in real time and interactively, the images captured and the results of the measurements performed.

The captured images may be fixed or moving, and the second operator may be a technician provided with high-performance analysis tools or an expert in a specific field of aircraft engines without leaving the scope of the invention.

According to one feature of the invention, the communication interface comprises a module for converting the video images from a data format specific to the endoscope used in situ to a data format suitable for processing by the remote terminal.

Said communication interface further comprises an audio communication module.

The device according to the invention further comprises a memory for saving the information and data exchanged between the operator and the expert.

The endoscope of the device according to the invention is connected to a video acquisition card of a laptop computer suitable for communicating in real time with the remote terminal via a wireless communication network.

The method for aiding remote-diagnosis according to the invention comprises the following steps:
capturing images and performing measurements in situ of the engine by means of an endoscope connected to a laptop computer,
establishing a wireless connection between the laptop computer and a remote terminal to analyse said images and said measurements and to establish a diagnosis;
exchanging in real time and interactively the images captured and the results of the measurements performed between the laptop computer and the remote terminal.

The method according to the invention further comprises conversion of the images captured and the results of the measurements performed from a data format specific to the apparatus used by the operator in situ to a data format suitable for processing by the remote terminal.

The method according to the invention is implemented by means of a computer program stored in memory on a storage medium and including instructions for carrying out the steps of said method when executed on a computer.

### BRIEF DESCRIPTION OF THE FIGURES

Further features and advantages of the invention will emerge from the description hereinafter, by way of non-limiting example, with reference to the appended figures wherein:

FIG. 1 schematically represents a device according to the invention,

FIG. 2 schematically represents a use of the device according to the invention.

### DETAILED DESCRIPTION OF PARTICULAR EMBODIMENTS

The invention also relates to a method for aiding remote-diagnosis in the course of an endoscopy of an aircraft engine carried out by one or a plurality of operators located on an aircraft inspection and testing site and receiving technical advice and decisions provided, by exchange of e-mails, by persons located on multiple remote sites; the exchanges may include text, images or videos, the decisions are made during interactive communications on the basis of this information.

In known procedures for aiding diagnosis, decision-making involves repeated iterations when there is a misunderstanding between the operators carrying out the tests and the experts analysing the results of these tests. This requires the operators to capture a very large number of images to avoid missing a critical zone of the inspected engine. However, in the field of aviation, for essential safety reasons, the sharing of technical information must be performed unambiguously. For this purpose, the remote experts need to have measurements, images and videos taken according to specific camera angles. Consequently, the experts need to be able to communicate without delay with the operators performing the measurements and capturing the images in order to guide them in the course of the tests. Most of the time, additional information is exchanged by e-mail. Besides the fact that these measurements mobilise staff and equipment for long periods, it may arise that the information received by the experts is not sufficient to enable them to establish a diagnosis.

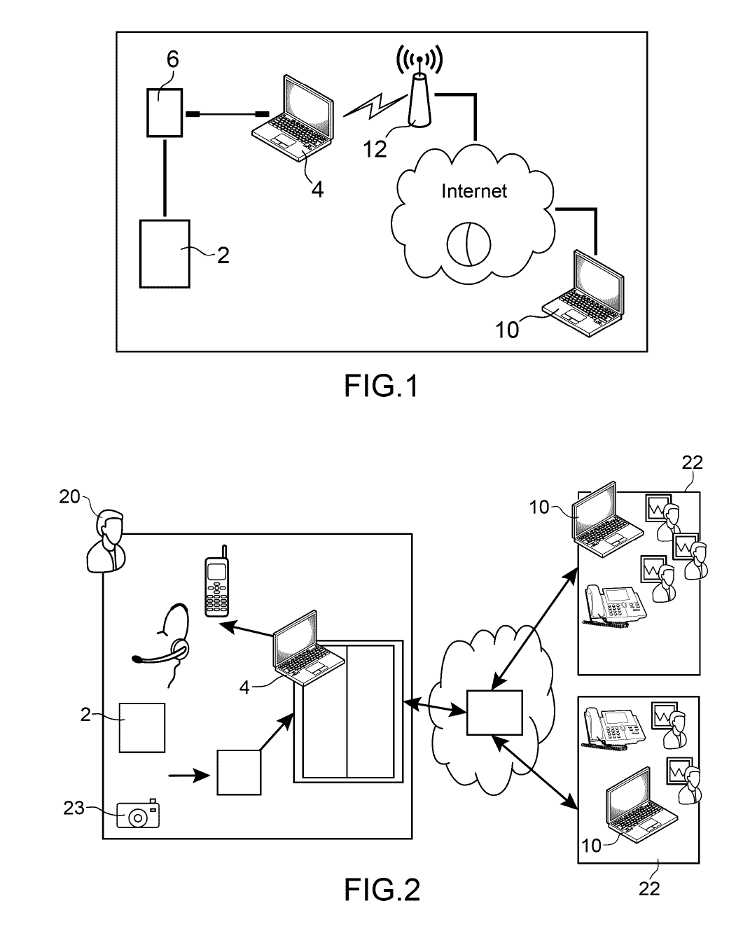

FIG. 1 schematically represents a device for aiding remote-diagnosis in the course of an endoscopy of an aircraft engine with an endoscope 2 intended to be used by an operator either at the foot of the aircraft wing or in development, test or maintenance facilities to capture images of the aircraft engine and to perform measurements. The endoscope 2 is connected to a laptop computer 4 via an image acquisition and conversion module 6. In order to exchange in real time the images captured and the results of the measurements between the endoscope 2 and a remote terminal 10, the laptop computer 4 is equipped with a wireless communication interface which provides an Internet connection via an antenna 12 arranged on the facility site.

With reference to FIG. 2, an operator 20 equipped with an endoscope or a camera 23 (or any image capture equipment equipped with an S-video VGA or composite analogue output) performs an endoscopy on an aircraft engine and transmits in real time the images captured and the results of the measurements to teams of experts 22 located on remote sites. The operator 20 and the experts 22 communicate via the Internet by means of video or image and/or audio sharing software and optionally via a mobile telephony network.

In operation, the operator 20 or the experts 22 start a collaboration session by logging into the video or image and/or audio sharing software. The operator performs the endoscopic inspection with synchronous exchange with the remote experts who monitor the progression of the operations live and optionally guide, verbally or via a visual interface, the operator in the course of the measurements and image or video capture. At the end of the session, the in situ operator has additional advice on the endoscopy carried out.

Note that the operator can change the endoscope or image capture equipment to refine the inspection without disrupting the exchanges insofar as the format of the images capture by means of the new equipment is automatically converted by the image acquisition and conversion module 6 into a format suitable for processing by the computer 4 and the terminals 10 of the experts 22.

If the experts deem the information received to be sufficient to establish a diagnosis, they transmit their diagnosis directly to the operator 20. At the end of the inspection, the shared session is terminated and the data (measurements, photos, video, conversations, etc.) exchanged during the session are stored.

The device according to the invention offers a hardware and software solution which is based on standardised interfaces and is suitable for all types of endoscopic and camera equipment (and for a single make and a single model) and for all propulsion assembly or component endoscopy or video contexts.

1. Device for aiding remote-diagnosis in the course of an endoscopy of an aircraft engine; comprising at least one endoscope (2) used in situ by a first operator (20) to capture images of said engine and to perform measurements, and at least one remote terminal (10) used by at least one second operator (22) to analyse said images and the results of said measurements in order to establish a diagnosis, the device further comprises a wireless communication interface allowing the first operator (20) to exchange with the second operator (22), in real time and interactively, the images captured and the results of the measurements performed, characterised in that said communication interface comprises a module (6) for the acquisition and automatic conversion of the video images from a data format specific to the endoscope (2) to a data format suitable for processing by a laptop computer (4) and by the remote terminal (10).

2. Device according to claim 1 wherein said communication interface further comprises an audio communication module.

3. Device according to claim 1 further comprising a memory for saving the information and data exchanged between the operator (20) and the second operator (22).

4. Device according to claim 1 wherein the endoscope (2) is connected to a video acquisition and conversion card of a laptop computer (4) suitable for communicating in real time with the remote terminal (10) via a wireless communication network.

5. Method for aiding remote-diagnosis in the course of an endoscopy of an aircraft engine characterised by the following steps:
capturing images and performing measurements of the engine by means of an endoscope connected to a laptop computer (4),
establishing a wireless connection between the laptop computer (4) and a remote terminal (10), to analyse said images and said measurements and to establish a diagnosis;
exchanging in real time and interactively the images captured and the results of the measurements performed between the laptop computer (4) and the remote terminal (10).
automatically converting the results of the measurements performed from a data format specific to the endoscope to a data format suitable for processing by the laptop computer (4) and by the remote terminal (10).

6. Computer program stored in memory on a storage medium and including instructions for carrying out the steps of the method when it is executed on a computer.
